(19) United States
(12) Patent Application Publication
(10) Pub. No.: US 2009/0077126 A1
(43) Pub. Date: Mar. 19, 2009

(54) METHOD AND SYSTEM FOR CALCULATING COMPETITIVENESS METRIC BETWEEN OBJECTS

(75) Inventors: Jianqiang LI, Beijing (CN); Yu ZHAO, Beijing (CN); Toshikazu FUKUSHIMA, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO,. LTD, Beijing (CN)

(21) Appl. No.: 12/233,335

(22) Filed: Sep. 18, 2008

(30) Foreign Application Priority Data
Sep. 19, 2007 (CN) 2007-10153592.0

(51) Int. Cl. G06F 17/30

(52) U.S. Cl. 707/103 Y; 707/E17.048

(57) ABSTRACT

Method and System for calculating competitiveness metric between objects are provided. The method comprises the steps of: obtaining a first object and a second object, the first and second objects having a first profile and a second profile, each composed of a plurality of attributes, respectively; normalizing the first profile and the second profile with reference to ontology information; and calculating, based on the normalized first and second profiles, a competitiveness metric between the first and second objects. In one embodiment, the ontology information is a common attribute name vocabulary, and the step of normalizing is configured for adjusting the structures of the first and second profiles to a unified profile structure, computing the sub-metrics between the corresponding attributes in the unified profile, and computing the weighed sum of the sub-metrics as the final competitiveness metric of the first and second objects. In another embodiment, the ontology information is an object category tree, and the step of normalizing is configured for mapping the first and second profiles to one or more nodes in the object category tree, computing the probabilities of mapping the profiles to different nodes, and then, based on the obtained semantic distances between the nodes, computing the final competitiveness metric according the probabilities and the semantic distances.

### FIELD OF THE INVENTION

This invention relates to information processing, and more particularly, to provide a method and system for calculating competitiveness metric between two objects (e.g., products/companies) to allow automatic competitor mining/finding.

### BACKGROUND

At present, the amount of information that people can acquire is increasingly rising. Since the original information is not externally visible, it is necessary to first process the original information and obtain useful information from it. Due to the requirements for the amount of information and the processing time, especially the rapid development of the network and communication technologies, certain information features, such as large amount of information, varieties of information and decentralization of information, become more and more obvious. In many applications, it is impossible to process information manually. Therefore, it is desirable to use some network and computer technologies, such as information extraction, mining, comparison, measurement, evaluation etc. to process the information. Among these computer technologies, an important information processing technology is to analyze and calculate automatically the competitiveness metric between objects (e.g., products/companies).

In today's competitive environment, particularly in a business scenario, almost every company wants to know who its competitors are, where they are, and what they are doing. However, it is a timing consuming and laborious task to find and watch the competitor, especially, in the globalization environment, where the competitor comes from all over the world and the players and their products in the market are continually changing.

Business Intelligence (BI) represents a broad category of technologies and applications required to turn raw data into information/knowledge and help enterprise users make better business decisions. Competitive Intelligence (CI), which is narrower in scope than BI, focuses specifically on gathering, analyzing, and managing information about the external business environment. Although these research/business disciplines have been established for a long time, currently the competitive information can only be obtained from three ways, i.e., 1) through field research interviews or networking with competitor staff or customers; 2) collecting the necessary information with the help of web search engine (e.g., Google) and the results are browsed and summarized by human; 3) from public or subscription sources, e.g., Yahoo Finance, D&B, info USA, Hoovers, and OneSource. 1) and 2) are totally based on human's activities/efforts, it is laborious and time consuming, and also the collected information scope is restricted. As for 3), there might be some commercial databases that comprise company information, however, their data scale is very limited, which means that most of them are in single language, includes only financial information (e.g., Yahoo Finance and D&B), or covers only local companies (e.g., info USA). In addition, since the information in these commercial databases is updated by human, it is difficult or even impossible to enable the subscriber/user to harvest real-time competitiveness relevant information in a large-scale way, especially in the global business environment.

Considering that the task of finding and watching the competitor is very laborious for human being, more efficient ways of competitive analysis are strongly required for computing the competitiveness metric between competitors (e.g. companies/products) according to certain intensional criterion.

Since the proposed competitiveness metric computation solutions borrow some ideas from similarity metric computation between two objects (documents/records), the relevant similarity metric computation approaches or solutions are summarized in the following.

At present, the methods and systems developed for similarity calculation between two documents or database records can be divided into two categories, i.e., Vector Space Model (VSM) based methods and attribute-value based methods.

VSM based methods are mainly adapted to be applied for computing the similarity metric between two full-text documents. Its basic idea is: each document is broken down into a word frequency vector; a vocabulary is built from all the words in all documents in the system; each document is represented as a vector based against the vocabulary; then a specific similarity measures (there are many similarity measures, among which cosine measure calculating the angle between the vectors in a high-dimensional virtual space is the most popular one) is adopted for the measuring how similar two documents are.

Attribute-value based similarity measurement methods mainly targets for structural documents/records with fixed and common schema. Similar with VSM based methods, firstly, the document is represented as a vector of attribute-values (each of which describes one aspect of the document/record); secondly, the similarity distance is calculated with respect to each of the attribute-values (during this process, many different similarity measures might be employed); thirdly, the classification of the attributes is conducted based on their contributions to the similarity metrics; finally, the weighting policy is applied to the classified attributes and the document/record similarity is measured as the weighted sum of the similarity of their attribute-values.

Furthermore, in order to overcome the language barrier for cross language document retrieval, translation-based and corpus-based approaches are proposed for similarity computing between two documents in different languages.

The translation-based approach, which exploits some thesaurus or multilingual dictionaries for similarity computing, mainly includes two steps: 1) using multilingual dictionary or machine-translation methods for the translation of the query or the targeted document set; 2) VSM/attribute-value based methods are adopted to realize cross language documents retrieval. Basically, it's a cross-lingual extension of the VSM or attribute-value based scoring.

Corpus-based approach, the alternative to use of a dictionary for text translation, is to directly exploit statistical information about term usage that can be gleaned from parallel corpora. Its implementation includes. 1) collecting parallel texts of different languages finding parallel corpus; 2) constructing statistical translation model; and 3) using the translation model for cross language information retrieval (the similarity computing is embedded inside).

The U.S. patent application No. 5301109 titled “Computerized Cross-Language Document Retrieval Using Latent Semantic Indexing” proposed a LSA based method, i.e., using singular value decomposition (SVD) to discover associations among source terms and target documents without query translation. The disclosure of this US patent application is hereby incorporated entirely by reference for all the purposes.

Besides the general solutions for similarity computation, some specific modules in the following patents are also relevant to the invention presented here, and are hereby incorporated entirely by reference for all the purposes:

(1) U.S. Pat. No. 5,731,991;

(2) U.S. Patent No. 20050004880A1;

(3) U.S. Patent No. 20050192930A1; and

(4) U.S. Patent No. 2004068413.

However, with respect to the competitiveness metric calculation, the disadvantages of the above-mentioned existing solutions are described as following.

Firstly, the existing solutions are proposed particularly for similarity computing between two documents/records. However, competitiveness computing is different from similarity computing, although intuitively their purpose (problem) is somewhat the same. Conceptually, competitive relation is a subset of similarity relation, i.e., similarity is a sufficient but unnecessary condition of competition. Two subjects is similar doesn't means that they compete with each other. More specifically, 1) their target objects are different: the relevant prior arts mainly focus on the similarity calculation between two free-text or structural documents/objects, competitiveness computing concerns any two subjects which might compete with each other; 2) their target relations are different: there are differences between definitions of competitiveness and similarity, i.e., the competitive relation means that the existence/development of one object has a negative influence on another object. Then, for measuring the competitiveness strength between two subjects competing with each other, the specific policies with respect to competitiveness are needed.

Secondly, all the current solutions for similarity computing assume that the targeted objects (i.e. documents/products) have the same schema (i.e., totally in full-text or with a specific data structure). The VSM-based method cannot handle the situation that one of the subjects to be compared has structural or semi-structural profile, and the attribute-value based method cannot handle the situations that one of the subjects to be compared has full-text profile or two subjects with heterogeneous structural profile. But in real applications, the objects needed to be compared might come from different information sources (e.g., disparate databases or different websites), which blocks the application of existing solutions.

Furthermore, the translation-based cross language similarity computing depends greatly on the quality of the control vocabulary or multilingual dictionaries and the machine translation technologies. The accuracy of current machine translation is not so high, and especially there is difficulty in unknown-term translation. Also, the complexity increases with respect to the combination of various languages.

For the corpus-based and LSA-based approaches, their biggest shortcoming is the unavailability of sufficient parallel corpora, which results in the obtained similarity metric biased by the limited parallel texts (the initially selected document set for the case of LSA).

Furthermore, the patents listed above can only be applied for a specific product category with a common and fixed attribute or feature structure. The adopted methods cannot be applied for cross category similarity computing. In addition, there is no comprehensive comparison between any two products to identify their competitive strength.

### SUMMARY OF THE INVENTION

In view of the above and other deficiencies and disadvantages of the existing methods in the prior art, the present invention is made. The purpose of the present invention is to provide a method and system for obtaining the competitiveness metric between two objects (e.g., products/companies).

According to one aspect of the present invention, it is provided a method for calculating competitiveness metric between objects, which comprises the steps of: obtaining a first object and a second object, the first and second objects having a first profile and a second profile, each composed of a plurality of attributes, respectively; normalizing the first profile and the second profile with reference to ontology information; and calculating, based on the normalized first and second profiles, a competitiveness metric between the first and second objects.

In one embodiment, the ontology information is a common attribute name vocabulary, and the profiles of different objects are compared in a direct way to obtain the competitiveness metric. First, the first and second profiles are normalized by using the corresponding ontology information, that is, a unified profile structure is generated by referring to the common attribute name vocabulary, and the respective attributes in the first and second profiles are aligned with the corresponding attributes in the unified profile. Then, the final competitiveness metric can be obtained by calculating a competitiveness sub-metric for each pair of corresponding attributes in the aligned first and second profiles and calculating the weighted sum of the competitiveness sub-metrics.

In another embodiment, the ontology information is an object category tree, of which each node represents an object category and includes one or more representative profiles. In this embodiment, the profiles of different objects are compared in a indirect way to obtain the competitiveness metric. First, the first and second profiles are normalized by using the corresponding ontology information, that is, the first and second profiles are mapped to one or more nodes of the object category tree respectively. Then, the final competitiveness metric can be obtained by referring to the semantic distance between each pair of nodes of the object category tree and the probabilities of mapping the profiles to the corresponding nodes.

According to another aspect of the present invention, it is provided a system for calculating competitiveness metric between objects, which comprises: an object obtaining means for obtaining a first object and a second object, the first and second objects having a first profile and a second profile, each composed of a plurality of attributes, respectively; a ontology information base for storing ontology information; a normalizing means for normalizing the first profile and the second profile using the ontology information from the ontology information base; and a competitiveness metric calculator for calculating, based on the normalized first and second profiles, a competitiveness metric between the first and second objects.

Corresponding to the method of the present invention, in different embodiments, the system can be used for computing the competitiveness metric between objects in the direct or indirect way described above.

In the direct way of competitiveness metric calculation, the profiles representing different objects are compared directly by aligning the corresponding attributes, and thus a flexible mechanism is provided to combine the word-based (VSM-based) and attribute-based methods in the domain of similarity computing. It enables the competitiveness metric calculation algorithm according to the present invention having the capability to handle the subjects with heterogeneous structural (attribute-value) and/or unstructured (plain text) profiles. Furthermore, the direct profile comparison method can take advantage of the profile data quality as much as possible to improve the accuracy of the final competitiveness metric.

Furthermore, through indirect competitiveness metric calculation, the language barrier is overcome for globalized competitor finding. Also, since the common taxonomic hierarchy (i.e. the object category tree) is used as a medium for competitiveness scoring, the efficiency can have a significantly improvement comparing with one-to-one profile comparison. In the method of indirect competitiveness metric calculation, there is no direct query/document translation (adopted popularly in the domain of cross-language information retrieval), and thus the corresponding shortcomings (e.g., unknown-term translation and complexity for translation based method, and unavailability of sufficient parallel corpora for corpus-based method) in the prior arts can be obviated.

The foregoing and other features and advantages of the present invention can become more obvious from the following description in combination with the accompanying drawings. Please note that the scope of the present invention is not limited to the examples or specific embodiments described herein.

### BRIEF DESCRIPTIONS OF THE DRAWINGS

The foregoing and other features of this invention may be more fully understood from the following description, when read together with the accompanying drawings in which:

FIG. 1 is a conceptual block diagram of the competitiveness metric calculation system 100 for illustrating the general idea of the present invention;

FIG. 2 is a flow chart diagram of an example of the operation of the competitiveness metric calculation system shown in FIG. 1;

FIG. 3 is a detailed block diagram of the competitiveness metric calculation system 300, which performs the normalization of the profiles by aligning the attributes according to the common attribute name vocabulary (i.e. the direct method), according to the first embodiment of the present invention;

FIG. 4 is a flow chart diagram for showing the operation of the system 300 shown in FIG. 3;

FIG. 5 shows an example of the attribute alignment process in the competitiveness metric calculation according to the first embodiment of the present invention;

FIG. 6 is a block diagram for showing in more details the competitiveness sub-metric calculating unit in FIG. 3;

FIG. 7 is a block diagram of the competitiveness sub-metric calculating unit in the case of selecting the VSM-based method to compute the sub-metrics of the attributes;

FIG. 8 is a detailed block diagram of the competitiveness metric calculation system 800, which performs the normalization of the profiles by mapping them to the nodes in the object category tree (i.e. the indirect method), according to the second embodiment of the present invention;

FIG. 9 is a flow chart diagram for showing the operation of the system 800 shown in FIG. 8;

FIG. 10 is a schematic diagram for showing the object category tree and the hierarchy of the representative profiles corresponding to the structure of the nodes in the object category tree;

FIG. 11 shows an example of the process for computing the competitiveness metric by mapping the profiles to the nodes in the object category tree according to the second embodiments; and

FIG. 12 is a schematic block diagram of the computer system that is used to implement the present invention.

### DETAILED DESCRIPTION OF THE PREFERRED EMBODIMENTS

As described above, the competitiveness relation is a newly defined relation, which is different from the well-known similarity relation. Almost all the current solutions for similarity computing in the prior art assume that the targeted subjects (i.e. documents/products) have the same schema. For example, VSM-based method cannot handle the situation that one of the subjects to be compared has structural or semi-structural profile, and the attribute-value based method cannot handle the situations that one of the subjects to be compared has full-text profile or two subjects with heterogeneous structural profile, which blocks the application of existing solutions.

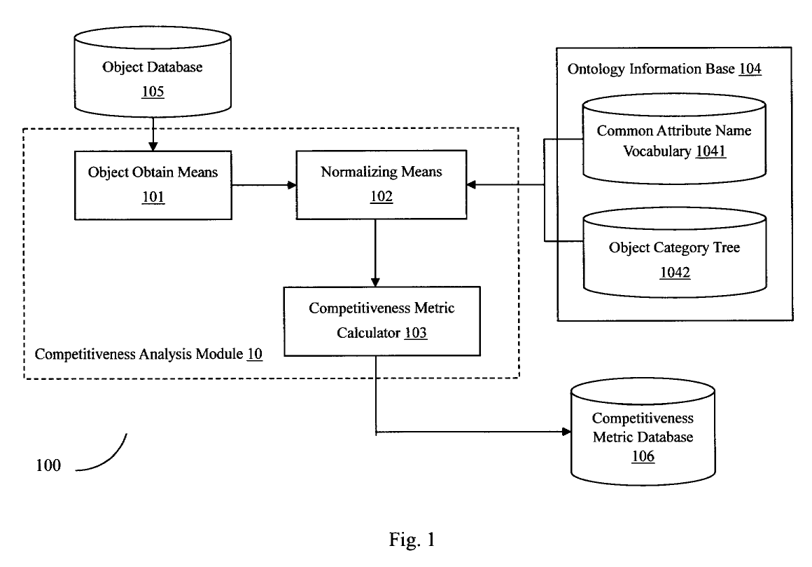

FIG. 1 is a conceptual block diagram of the competitiveness metric calculation system 100 for illustrating the general idea of the present invention. As shown in FIG. 1, the major part of the system 100 is a competitiveness analysis module 10, which includes an object obtain means 101, a normalizing means 102 and a competitiveness metric calculator 103. Furthermore, the system 100 further comprises an ontology information base 104, an object database 105 and a competitiveness metric database 106, wherein the object database 105 stores the objects (e.g. documents) collected from the Web or other information sources by applications for analysis and processing of the competitiveness analysis module 10. The ontology information base 104 is configured for storing ontology information (i.e. background knowledge) referred by the competitiveness analysis module 10 for computing the competitiveness metric. The ontology information is a common understanding of the interested domain about the categorization of the subjects in corresponding domain, and can be set up in a manual or (semi-) automatic way in advance. For example, the ontology information may include a common attribute name vocabulary 1041 and an object category tree 1042, which will be described in detail later. The competitiveness metric database 106 is used for storing the calculated competitiveness metric.

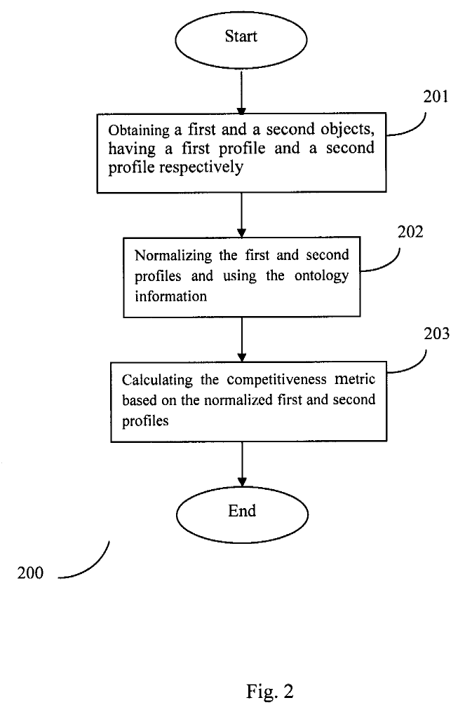

FIG. 2 is a flow chart diagram of an example of the operation of the system 100 shown in FIG. 1. The process begins with step 201 where a first and a second objects to be compared are obtained from the object database 105. The first and second objects are characterized by a first profile A and a second profile B respectively. Since the objects might be collected from multiple sources, even for the same category object, the resulting first and second profiles A and B might be of different structures, such as in full-text or heterogeneous structures. Here, we use a set of attribute-values to specify the resultant profiles, for example, A=(A1−V_{A}1, A2−V_{A}2, . . . , Am−V_{A}m) and B=(B1−V_{B}1, B2−V_{B}2, . . . , Bn−V_{B}n), where Ai is the ith attribute in the profile A, V_{A}i is the value of the ith attribute in the profile A. Similarly, Bi is the ith attribute in the profile B, V_{B}i is the value of the ith attribute in the profile B. Basically, the value is utilized to describe the attribute, which can be a digital number, a mixed string by digital number and English characters (and/or Chinese characters, and/or punctuations), a piece of text, and so on. A full-text profile is treated as a special case of structural profile that it has only one pair of attribute-value. Next, in step 202, the ontology information from the ontology information base 104, such as the common attribute name vocabulary 1041 or the object category tree 1042, is referred to normalize the first profile A and the second profile B so as to facilitate the competitiveness metric computation. As described in detail later, the step of normalizing can be implemented by: (1) referring to the common attribute name vocabulary 1041 to determine a unified profile structure and aligning the first and second profiles A and B with the unified profile in their structures (hereinafter, which is referred to as “direct way”); or (2) mapping the first profile A and the second profile B to the object category tree 1042 (hereinafter, which is referred to as “indirect way”). Then, in step 203, the normalized first and second profiles A and B can be used to compute the competitiveness metric between the first and second objects.

Below the exemplified embodiments of the present invention will be described with reference to the accompanying drawings. It should be noted that the described embodiments are only used for the purpose of illustration, and the present invention is not limited to any of the specific embodiments described herein.

### The First Embodiment

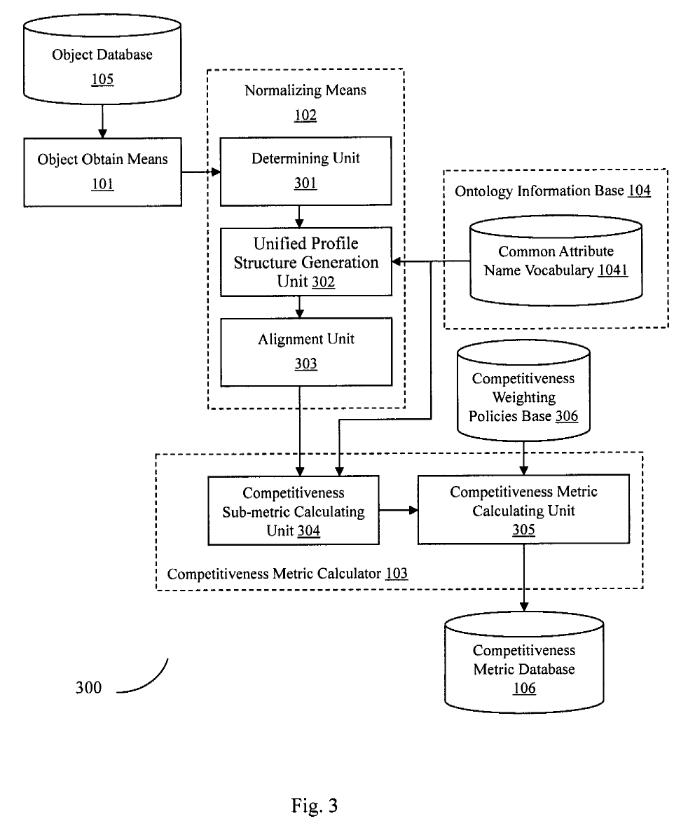

First, the first embodiment of the present invention will be described with reference to FIGS. 3-7. As shown in FIG. 3, which shows a block diagram of the competitiveness metric calculation system 300 according to the first embodiment of the present invention, the profiles are normalized by aligning the attributes of the profiles according to the common attribute name vocabulary, namely, in the direct way.

As shown in FIG. 3, in this embodiment, the common attribute name vocabulary 1041 is considered as the ontology information. The normalizing means 102 includes a determining unit 301, a unified profile structure generation unit 302 and an alignment unit 303. The competitiveness metric calculator 103 includes a competitiveness sub-metric calculating unit 304 and a competitiveness metric calculating unit 305. Furthermore, the system 300 also includes a competitiveness weighting policies base 306 for providing domain-specific competitiveness weighting strategies, which will be described in detail later.

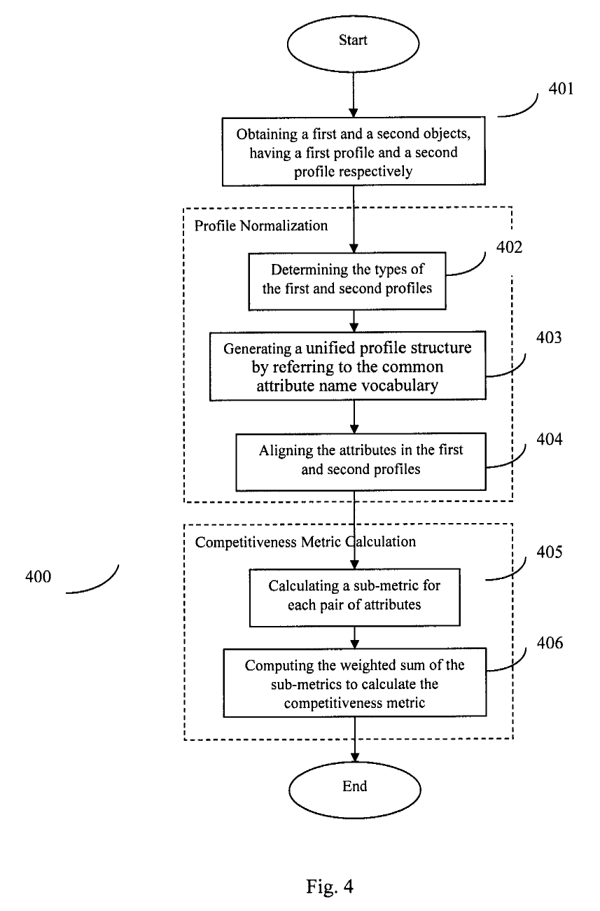

Below, the operation of the system 300 will be described first with reference to FIG. 4.

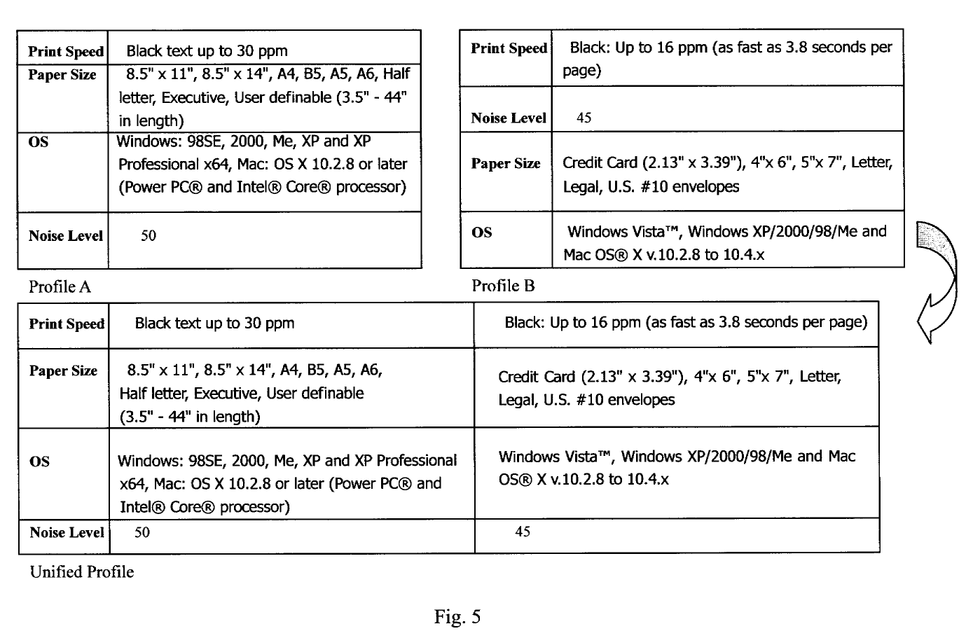

Like FIG. 2, the process begins with step 401 where the object obtain means 101 obtains a first and a second objects to be compared from the object database 105. The first and second objects have a first profile A=(A1−V_{A}1, A2−V_{A}2, . . . , Am−V_{A}m) and a second profile B=(B1−V_{B}1, B2−V_{B}2, . . . , Bn−V_{B}n) respectively. Next, in step 402, the determining unit 301 determines the types of the first and second profiles A and B. With this operation, the structures of the first and second profiles A and B are analyzed to determine if they are full-text or structural profiles, for the structural profile, what its schema is. Then in step 403, the unified profile structure generation unit 302 receives the result of the structure analysis from the determining unit 301, and with the support of the common attribute name vocabulary 1041, determines a unified profile structure (C1, C2, . . . Cs), namely, A=(C1−V_{A}1, C2−V_{A}2, . . . , Cs−V_{A}s) and B=(C1−V_{B}1, C2−V_{B}2, . . . , Cs−V_{B}s). Based on the determined unified profile structure and the common attribute name vocabulary 1041, the alignment unit 303 reorganizes the structures of the first and second profiles A and B to align the attributes in the first and second profiles A and B in their structures with the corresponding attributes in the unified profile (step 404). FIG. 5 shows an example of the attribute alignment process, wherein the profiles to be compared involve two kinds of printers, which includes the attributes of “Print Speed”, “Paper Size”, “OS” and “Noise Level”. As shown, the structures of the attributes in the first profile A and the second profile B are aligned according to the structure of the unified profile.

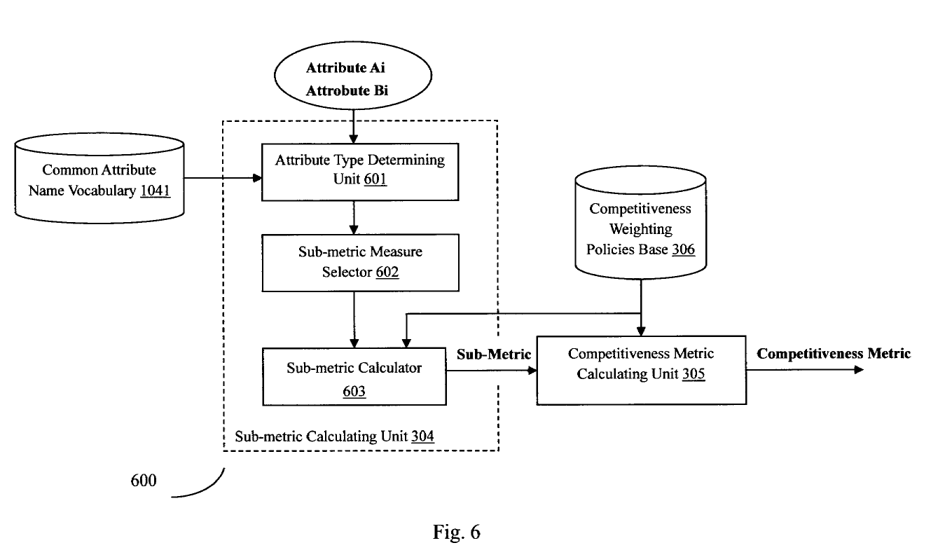

Then, in step 405, the aligned first profile A and second profile B are sent to the competitiveness sub-metric calculating unit 304 to compute the sub-metric of each of the attributes. The structure of the competitiveness sub-metric calculating unit 304 is shown in FIG. 6. The competitiveness sub-metric calculating unit 304 includes an attribute type determining unit 601, a sub-metric measure selector 602 and a sub-metric calculator 603. As shown, two attributes (values) Aᵢ=Cᵢ−V_{A}i and Bᵢ=Ci−V_{B}i are first input to the attribute type determining unit 601. Here, the attributes Aᵢ and Bᵢ are belonged to the first profile A and the second profile B respectively and are aligned in their structures. As described above, each attribute-value is the specification about one aspect of the object (e.g. product), where the attribute name indicates which aspect of the object is described and the value includes the content to describe the attribute. The content of an attribute can be single-value or multi-value, and the attribute-value might be a simple data type or a complex data type. Typically, with respect to different data types, the computing methods for the competitiveness sub-metric are different. Generally, the single-value attributes are further divided into two cases: 1) for the attribute whose value is symbolic (e.g., enumeration data type or plain text); and 2) for the attribute whose value is numeric (e.g., float). For the symbolic attributes (e.g. full-text), a VSM-based method is often used for computing the competitiveness sub-metric, while for the numeric attributes, an attribute-value based method is used for computing the competitiveness sub-metric. The multi-value attributes are employed for handling the attribute with a set of values, which are also divided into two cases: 1) for the attribute whose multiple values are in sequence; 2) for the attribute whose multiple values are without sequence. In a real implementation, the competitiveness metric computing methods for the multi-value attributes might access the functionalities provided by the methods on the single-value attributes. About the determination of the content of the attribute and the data type, there are many methods capable of being introduced from the existing similarity measurement methods in the art, and thus their detailed description will be omitted here. Also, it should be noted that these cases are examples only and the present invention may be implemented in a different manner utilizing different data type definitions.

Next, according to the measurement method selected by the sub-metric measure selector 602, the sub-metric calculator 603 is used to compute the competitiveness sub-metric cᵢ (Aᵢ, Bᵢ) between the attributes Aᵢ and Bᵢ.

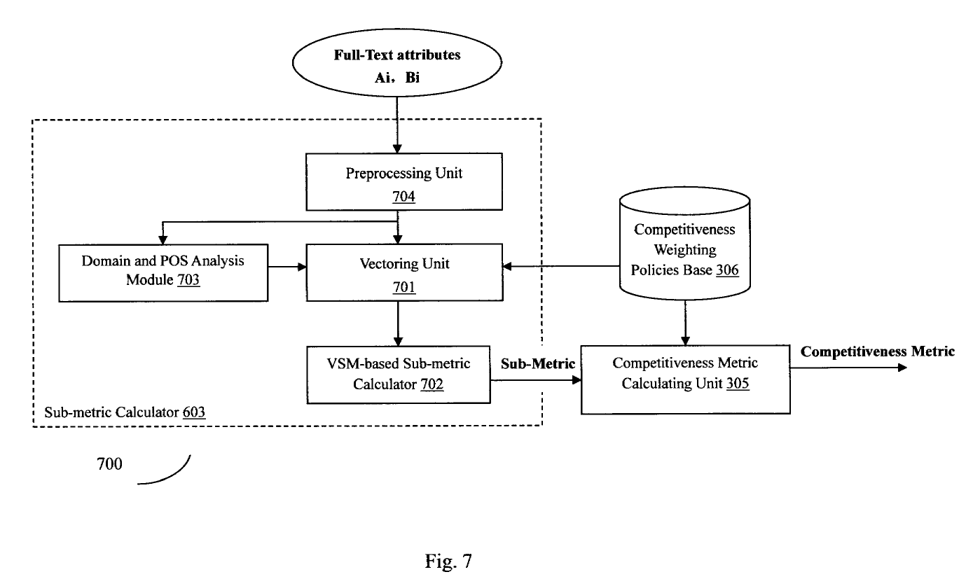

As described above, for the case that the value of an attribute comprises full-text content, the VSM-based similarity computing method can be adopted for computing the competitiveness sub-metric between the attributes. The detailed description will be given below with reference to FIG. 7. Basically, the VSM represents documents as a feature vector of the terms (words) that appear in the set of all the documents. In some embodiments, for example, when processing Chinese or Japanese documents, before generating the corresponding feature vector, it is necessary to first perform a domain and part of speech (POS) analysis on the terms (words) in the documents and apply weight strategies according to the analysis result. Similarity between documents is measured using one of several similarity measures (e.g., the Cosine and the Jaccard measures) that are based on such a feature vector.

FIG. 7 is a block diagram of the competitiveness sub-metric calculating unit when selecting the VSM-based method to compute the sub-metric of the attributes Aᵢ and Bᵢ in the case of the attribute type being determined as full-text. As shown in FIG. 7, in this example, the sub-metric calculator 603 includes a vectoring unit 701, a VSM-based sub-metric calculator 702 and a preprocessing unit 704. First, the full-text attributes Aᵢ and Bᵢ can be input into the preprocessing unit 704, where the name entities, such as the proper nouns, the product/company names, are deleted first since these name entities has no use for evaluating the competitiveness. As such, the accuracy of the competitiveness metric computation can be improved. Then, the preprocessed attributes Aᵢ and Bᵢ are input into the vectoring unit 701 for generating word-based vectors representing the full-text attributes Aᵢ and Bᵢ. Here, in order to further improve the accuracy of the competitiveness metric computation, a domain and POS analysis module 703 and a competitiveness weighting policies base 306 can be incorporated. Based on the analysis result of the domain and POS analysis module 703 for the relevant domain and POS of each word in the full-text attributes Aᵢ and Bᵢ, a rule table of the competitiveness weighting coefficients stored previously in the competitiveness weighting policies base 306 can be used to assign different competitiveness weighting coefficients (weights) to different words. In the full-text (structural) profile, a competitiveness coefficient is associated with each word (attribute), which is used to represent the importance of the word (attribute) in the competitiveness metric computation, through which the context-aware competitiveness weighting policies can be applied to improve the final accuracy. For example, when comparing two products from security software domain, the words “firewall, spam, invasion, virus” has higher coefficient (weight) value than the domain un-related words. With the analysis of the domain and POS analysis module 703, the preposition, conjunction, auxiliary words, interpunction, pronoun, exclamation, modal words, and onomatopoeic words make no contribution to the final metric, their competitiveness coefficient is set to be zero. In a real implementation, the rule table of the competitiveness weighting coefficients in the competitiveness weighting policies base 306 can be built manually or through some automatic way, e.g., keywords extraction based on the ontological product information from some 3^{rd} party websites (the words happened in the attribute-value of the structural profile with higher weights). However, the present invention is not limited to the specific examples, other methods for generating the rule table of the competitiveness weighting coefficients can also be used here.

Then, the word-based vectors representing the full-text attributes Aᵢ and Bᵢ generated by the vectoring unit 701 are input to the VSM-based sub-metric calculator 702 to generate the sub-metric Cᵢ (Aᵢ, Bᵢ) between the attributes Aᵢ and Bᵢ using some existing VSM-based method.

Next, turning back to FIG. 4, in step 406, the sub-metrics of all the attributes in the aligned first and second profiles A and B are input to the competitiveness metric calculating unit 305 to calculate the final competitiveness metric between the first and second objects. As shown in FIG. 3, the calculated competitiveness metric will be stored in the competitiveness metric database 106. The competitiveness metric calculating unit 305 can obtain the final competitiveness metric in any of the known appropriate methods based on the sub-metrics of respective attributes. In the embodiment, the competitiveness metric calculating unit 305 obtains the final competitiveness metric by computing the weighed sum of the sub-metrics. In the embodiment, different weights have been assigned previously to respective attributes according to the common attribute name vocabulary 1041, and stored in the competitiveness weighting policies base 306. Therefore, the competitiveness metric of the first and second objects can be realized as:

$$Com ( A , B ) = {\sum }_{i = 1}^{s} {w}_{i} {c}_{i} ( {A}_{i} , {B}_{i} ) / {\sum }_{i = 1}^{s} {w}_{i} \qquad ( 1 )$$

wherein A and B are two profiles with a common structure that has s number of attributes, A (A₁, . . . , Aₛ) and B=(B₁, . . . , Bₛ), cᵢ(Aᵢ, Bᵢ) is the competitiveness sub-metric of the ith attributes of the two profiles, wᵢ is the weight assigned to the ith attribute. As described above, the competitiveness weighting policies are from the competitiveness weighting policies base 306. Then, the process shown in FIG. 4 ends.

### The Second Embodiment

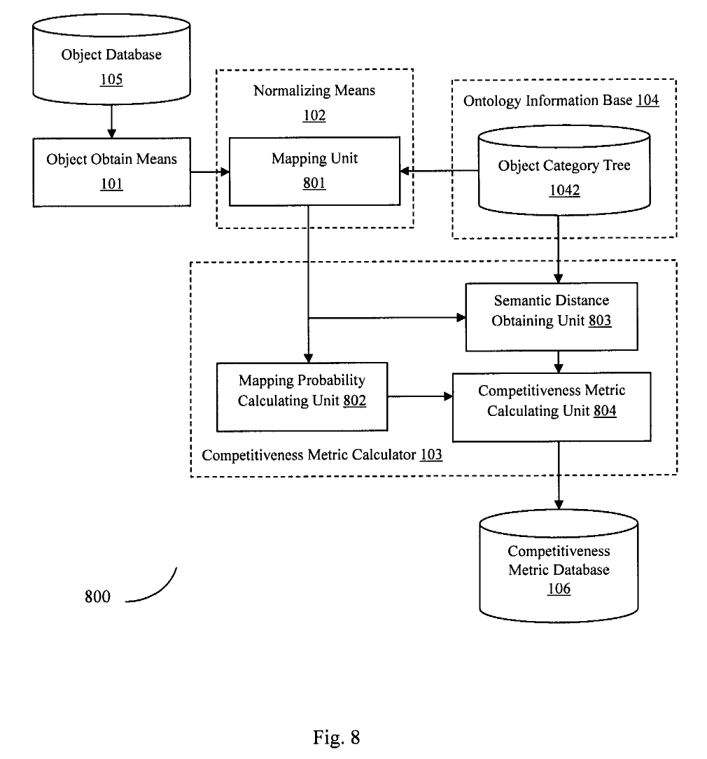

Below, the second embodiment of the present invention will be described with reference to FIGS. 8-11. FIG. 8 is a detailed block diagram of the competitiveness metric calculation system 800, which performs the normalization of the profiles by mapping them to the nodes in the object category tree (i.e. the indirect method), according to the second embodiment of the present invention. Differently from the first embodiment, as shown in FIG. 8, an object category tree 1042 is used as the ontology information for normalizing the profiles. The normalizing means 102 includes only a mapping unit 801, which receives the first object and the second object from the object obtain means 101, and maps the corresponding first and second profiles A and B to one or more nodes in the object category tree 1042. In this embodiment, the competitiveness metric calculator 103 includes a mapping probability calculating unit 802, a semantic distance obtaining unit 803 and a competitiveness metric calculating unit 804, which will be described in detail later, and is configured for computing the competitiveness metric between the first and second objects.

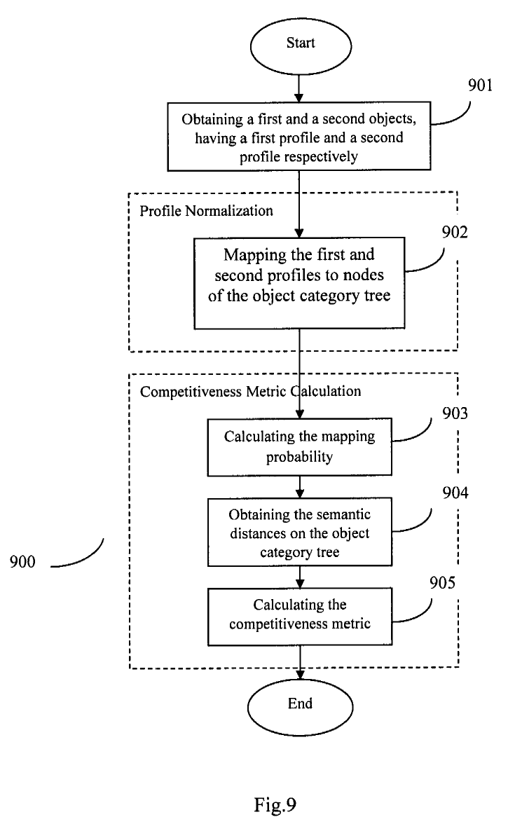

FIG. 9 shows a flow chart diagram for showing the operation of the system 800 shown in FIG. 8. Like the first embodiment shown in FIG. 4, the process 900 begins with the step 901, where a first and a second objects having a first profile A and a second profile B respectively are obtained from the object database 105. Next, in step 902, the first profile A and the second profile B are mapped to one or more nodes in the object category tree 1042.

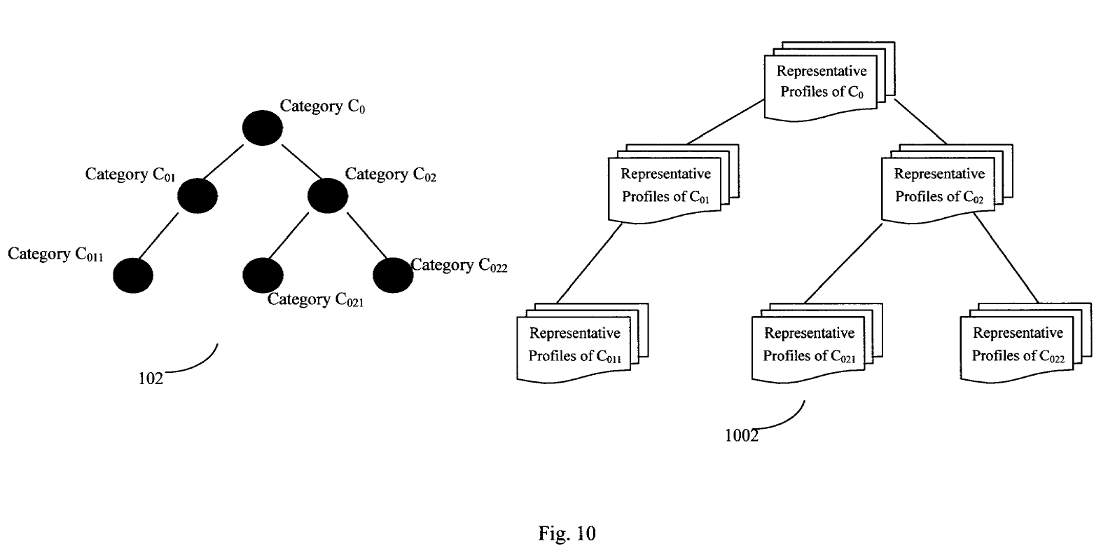

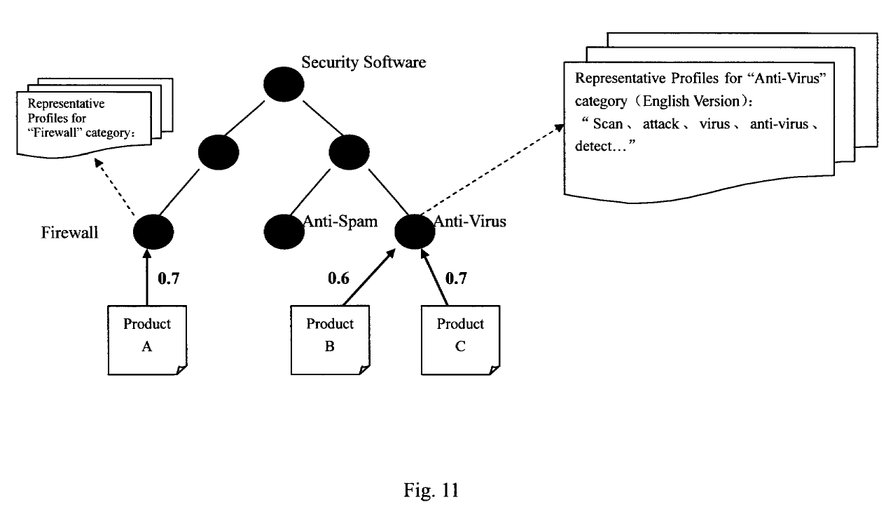

FIG. 10 is a schematic diagram for showing an object category tree 102 and the hierarchy 1002 of the representative profiles corresponding to the structure of the nodes in the object category tree 102. FIG. 11 shows an example of the computation of the competitiveness metric according to the second embodiment. As described above, the object category tree 102 is a common understanding of the interested domain about the categorization of the objects (e.g. documents) in corresponding domain, where each node stands for one category. As shown in FIG. 10, the root category of the domain is C₀, which includes two subcategories, i.e. C₀₁ and C₀₂. The subcategory C₀₁ further includes a subcategory C₀₁₁, while the subcategory C₀₂ further includes two subcategories C₀₂₁ and C₀₂₂. In the practical application, the object category tree 102 can be obtained in advance in any of the well-known automatic or semi-automatic ways. For example, as shown in FIG. 11, in the security software domain, the root node of the object category tree 102 corresponds to a “Security Software” category, which further includes three leaves nodes, i.e. a “Firewall” category, a “Anti-Spam” category and a “Anti-Virus” category. Off course, the structure of the object category tree 102 is not limited to the shown example, and in different domains, the user can set different object category trees according to different requirements. Return to FIG. 10, it also shows a hierarchy 1002 of the representative profiles corresponding to the structure of the object category tree 102. Each node of the representative profiles hierarchy 1002 includes one or more representative profiles included in the object category at the corresponding node in the object category tree 102. The representative profile includes all the relevant keywords for describing the object category at the corresponding node. At each of the nodes, the representative profile is language-dependent, that is, there is a representative profile at each of the nodes corresponding to each specific language. The representative profiles hierarchy 1002 formed by representative profiles can be obtained in advance in any of the well-known automatic or semi-automatic ways.

Return to the step 902 of FIG. 9, in that step, the obtained first profile A and second profile B are mapped to one or more nodes in the object category tree 102, which can be achieved by existing VSM-based methods. In an embodiment, the mapping process is performed by taking the representative profiles in the representative profiles hierarchy 1002 as a medium. That is, the similarity between the profile (A or B) and the node/category at the corresponding position in the object category tree 102 can be computed by comparing the contents of each of the first and second profiles A and B with the representative profiles in the representative profiles hierarchy 1002 by using conventional VSM-based methods, so as to determine one or more (depending to the practical implementation) categories the corresponding object should belong to.

After determining the categories of the compared profiles A and B, the mapping result is sent to the competitiveness metric calculator 103 to compute the competitiveness metric between the first and second objects. As shown in FIG. 9, the process for computing the competitiveness metric mainly includes three steps, i.e. steps 903, 904 and 905. First, in step 903, the probabilities of mapping the first and second profiles A and B to different nodes are computed. As shown in FIG. 11, the product A is mapped to the “Firewall” category node in a probability of 0.7, the product B is mapped to the “Anti-Virus” category node in a probability of 0.6, and the product C is mapped to the “Anti-Virus” category node in a probability of 0.7. Then, the semantic distances between the nodes in the object category tree 102 are obtained in step 904. The semantic distance is used for characterizing the similarity between the object categories at the corresponding nodes, and can be computed previously with existing similarity metric computation methods and stored in the ontology information base 104. Assume that the distance between categories c1 and c2 is denoted as dc (c1, c2), then the similarity between the two categories is defined as corn (c1, c2)=1−dc (c1, c2). Here, the semantic distance between two categories is computed according to their respective positions on the object category tree 102. Generally, the basic idea is that the distances between upper level categories are bigger than those between lower level categories, and thus the similarity between upper level categories is smaller than that between lower level categories. Furthermore, the distance between ‘brothers’ should be longer than that between ‘father’ and ‘son’. Then, in step 905, the competitiveness metric between the first and second objects is computed by referring to the probabilities in which the first and second profiles A and B are mapped to the corresponding nodes and the obtained semantic distances between these nodes, which are obtained in steps 903 and 904. Here, the following two typical example cases are considered: (1) each of the first and second profiles A and B is mapped to only one node (category); or (2) the profiles A and B can be mapped to a plurality of nodes. In the case of describing that each of the profiles A and B is mapped to only one node, the probabilities of mapping the first and second profiles A and B to the corresponding nodes are 1. In this regard, the pre-calculated semantic distance between the two categories is utilized directly to measure the competitiveness between the first and second objects from the corresponding categories. That is, assume that the product A is only mapped to the category C₀₁₁ and the product B is only mapped to the category C₀₂₁, and the semantic distance between the categories C₀₁₁ and C₀₂₁ is 0.1, then the competitiveness metric between the product A and the product B is 0.1. Furthermore, in the case that the profiles A and B are mapped to a plurality of categories, the competitiveness metric can be computed by utilizing a cosine measure according to the probabilities in which the first and second profiles A and B are mapped to the corresponding nodes. In such a case, we can set two category vectors d_{A} and d_{B} for the profiles A and B respectively, and each element in one category vector denotes the probability of mapping the profile to a corresponding category. Then, a cosine measure

$$\frac{{d}_{A} \times {d}_{B}}{\vert {d}_{A} \vert \vert {d}_{B} \vert}$$

can be used to compute the competitiveness metric between the first and second objects having the first and second profiles A and B respectively. It should be noted that the semantic distances between different nodes are omitted here. However, it is easy to be conceived for those skilled in the art that the semantic distances between different nodes can also be integrated by using any of the suitable methods so as to improve the accuracy of the competitiveness metric computation.

For example, in the example shown in FIG. 11, the product A is mapped to the “Firewall” category node in a probability of 0.7, the product B is mapped to the “Anti-Virus” category node in a probability of 0.6, and the product C is mapped to the “Anti-Virus” category node in a probability of 0.7. Assume that the semantic distance between the “Firewall” node and the “Anti-Virus” node is computed previously as 0.1, then the competitiveness metric between the products A and B (belonging to different categories) can be computed as 0.7×0.6×0.1=0.042, and the competitiveness metric between the products B and C (belonging to the same categories) can be computed as 0.7×0.6=0.42. The competitiveness metric computing method is not limited to the example. Then, the process shown in FIG. 9 ends.

Furthermore, as described above, the representative profiles at different nodes of the representative profiles hierarchy 1002 can be dependent on different languages. Therefore, the profiles A and B, which relate to different objects, can have different languages.

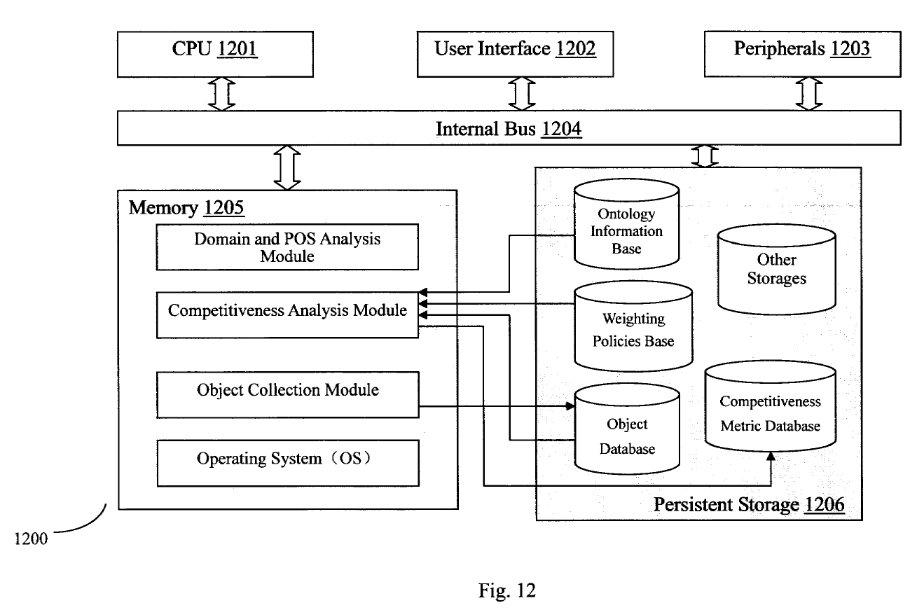

FIG. 12 is a schematic block diagram of the computer system 1200 that is used to implement the present invention. As shown, the computer system 1200 includes a CPU 1201, a user interface 1202, the peripherals 1203, a memory 1205, a persistent storage 1206 and an internal bus 1204, which connects the foregoing components with each other. The memory 1205 further includes a domain and POS analysis module, a competitiveness analysis module, an object collection module and an operating system (OS) etc. The present invention is mainly related to the competitiveness analysis module, which is, for example, the competitiveness analysis module 10 shown in FIG. 1. The object collection module can collect objects from different sources and store them in an object database. The domain and POS analysis module is used for processing the attributes in the case of the full-text profile, which is, for example, the domain and POS analysis module 703 shown in FIG. 7. The persistent storage 1206 stores the various databases related to the present invention, such as the ontology information base 104, the competitiveness weighting policies base 306, the object database 105 and the competitiveness metric database 106 etc.

The first embodiment (competitiveness metric computation in the direct way) and the second embodiment (competitiveness metric computation in the indirect way) of the present invention have been described above with reference to the accompanying drawings. From the above description, the effects of the present invention are as follows.

In the direct way of competitiveness metric calculation, the profiles representing different objects are compared directly by aligning the corresponding attributes, and thus a flexible mechanism is provided to combine the word-based (VSM-based) and attribute-based methods in the domain of similarity computing. It enables the competitiveness metric calculation algorithm according to the present invention having the capability to handle the subjects with heterogeneous structural (attribute-value) and/or unstructured (plain text) profiles. Furthermore, the direct profile comparison method can take advantage of the profile data quality as much as possible to improve the accuracy of the final competitiveness metric.

Furthermore, through indirect competitiveness metric calculation, the language barrier is overcome for globalized competitor finding. Also, since the common taxonomic hierarchy (i.e. the object category tree) is used as a medium for competitiveness scoring, the efficiency can have a significantly improvement comparing with one-to-one profile comparison. In the method of indirect competitiveness metric calculation, there is no direct query/document translation (adopted popularly in the domain of cross-language information retrieval), and thus the corresponding shortcomings (e.g., unknown-term translation and complexity for translation based method, and unavailability of sufficient parallel corpora for corpus-based method) in the prior arts can be obviated.

It should be noted that the competitiveness metric computing method of the present invention could also be applied to the similarity computation in order to improve the accuracy of the current similarity metric computing technologies.

The specific embodiments of the present invention have been described above with reference to the accompanying drawings. However, the present invention is not limited to the particular configuration and processing shown in the accompanying drawings. For example, in the process of computing the competitiveness sub-metric between different attributes, in addition to the VSM-based method and the attribute-value based method, any of the other similarity measurement technologies known in the art can also be used. Also, for the purpose of simplification, the description to these existing methods and technologies is omitted here.

In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of a machine-readable medium include electronic circuit, semiconductor memory device, ROM, flash memory, erasable ROM (EROM), floppy diskette, CD-ROM, optical disk, hard disk, fiber optic medium, radio frequency (RF) link, etc. The code segments may be downloaded via computer networks such as the Internet, Intranet, etc.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for calculating competitiveness metric between objects, comprising:
obtaining a first object and a second object, the first and second objects having a first profile and a second profile, each composed of a plurality of attributes, respectively;
normalizing the first profile and the second profile with reference to ontology information; and
calculating, based on the normalized first and second profiles, a competitiveness metric between the first and second objects.

2. The method according to claim 1, wherein the ontology information is a common attribute name vocabulary, which includes the names of object's attributes selected by importance for the competitiveness of the attributes, and
wherein normalizing the first and second profiles comprises:
determining profile types of the first and second profiles;
according to the determined profile types, generating a unified profile structure by referring to the common attribute name vocabulary; and
aligning the respective attributes in the first and second profiles with the corresponding attributes in the unified profile, and
wherein calculating the competitiveness metric comprises:
calculating a competitiveness sub-metric for each pair of corresponding attributes in the aligned first and second profiles; and
obtaining the competitiveness metric between the first and second objects by calculating the weighted sum of the competitiveness sub-metrics of all attributes in the first and second profiles.

3. The method according to claim 1, wherein the ontology information is an object category tree, of which each node represents an object category and includes one or more representative profiles, and
wherein normalizing the first and second profiles comprises:
mapping each of the first and second profiles to one or more nodes of the object category tree, and
wherein calculating the competitiveness metric comprises:
obtaining a semantic distance between each pair of nodes of the object category tree; and
calculating the competitiveness metric between the first and second objects based on the obtained semantic distances.

4. The method according to claim 3, wherein calculating the competitiveness metric further comprises calculating, for each of the first and second profiles, a probability of mapping it to each of corresponding nodes of the object category tree, and wherein the competitiveness metric between the first and second objects based on is calculated based on the calculated mapping probabilities of the first and second profiles and the obtained semantic distances between the nodes to which the first and second profiles are mapped.

5. The method according to claim 2, wherein calculating the competitiveness sub-metric comprises:
with respect to each pair of corresponding attributes in the first and second profiles, namely, a first attributes from the first profile and a second attribute from the second profile:
determining the type of the first and second attributes with reference to the common attribute name vocabulary;
selecting a competitiveness sub-metric measure according to the determined attribute type;
calculating the competitiveness sub-metric between the first and second attribute with the selected competitiveness sub-metric measure.

6. The method according to claim 5, wherein the competitiveness sub-metric measure is a Vector Space Model (VSM)-based measure or an attribute-based measure.

7. The method according to claim 6, wherein when the VSM-based measure is used to calculate the competitiveness sub-metric, the step of calculating the competitiveness sub-metric further comprises:
generating a first vector and a second vector, which are both based on words, representative of the first and second attributes respectively;
using the VSM-based measure to calculate a competitiveness metric between the first and second vectors as the competitiveness sub-metric between the first and second attributes.

8. The method according to claim 7, further comprising:
preprocessing the first and second attributes to delete named entities from text of each attribute's value before generating the first and second vectors.

9. The method according to claim 8, wherein the named entities include proper none, company name and product name.

10. The method according to claim 7, further comprising:
performing a domain and part-of-speech (POS) analysis on the words in the first and second attributes; and
before generating the first and second vectors, according to the result of the domain and POS analysis, weighting the words in the first and second attributes with reference to a previously stored competitiveness weight coefficients rules table related to the competitiveness.

11. The method according to claim 7, wherein the competitiveness weight coefficients rules table is built manually by user.

12. The method according to claim 7, wherein the competitiveness weight coefficients rules table is built through an automatic way by performing keywords extraction based on the ontological object information from third party websites.

13. The method according to claim 7, wherein the competitiveness weight coefficients rules table is configured for storing a competitiveness weight coefficient associated with each word, which represents the importance of the word in calculating the competitiveness metric.

14. The method according to claim 13, wherein in the competitiveness weight coefficients rules table, a word un-related to the domain to which the compared first and second objects belong is provided a lower competitiveness weight coefficient than a word related to the domain, and for the words which each has a POS making no contribution to the calculation of the competitiveness metric, their competitiveness weight coefficients are set to zero.

15. The method according to claim 3, wherein the one or more representative profiles at each node correspond to different languages.

16. The method according to claim 3, wherein the one or more representative profiles at each node of the object category tree are used as a medium to perform the mapping of the first and second profiles to the nodes of the object category tree by using a VSM-based measure.

17. The method according to claim 3, wherein when each of the first and second profiles is mapped to a single node, the semantic distance between the mapped nodes is used directly as the competitiveness metric between the first and second objects.

18. The method according to claim 4, wherein when each of the first and second profiles is mapped to a plurality of nodes, a first category vector and a second category vector are generated based on the probabilities of mapping the first and second profiles to the respective nodes of the object category tree, and the competitiveness metric between the first and second objects is calculated by utilizing a cosine measure of the first and second category vectors.

19. The method according to claim 18, wherein the semantic distances between the nodes that the first and second profiles are mapped to are integrated into the cosine measure to calculate the competitiveness metric between the first and second objects.

20. The method according to claim 3, wherein the semantic distances between respective nodes of the object category tree are computed in advance and stored with the object category tree.

21. The method according to claim 3, wherein on the object category tree, a semantic distance between nodes in a higher level is bigger than that between nodes in a lower level, and a semantic distance between “sibling” nodes is bigger than that between a “parent” node and a “child” node.

22. A system for calculating competitiveness metric between objects, comprising:
an object obtaining means for obtaining a first object and a second object, the first and second objects having a first profile and a second profile, each composed of a plurality of attributes, respectively;
a ontology information base for storing ontology information;
a normalizing means for normalizing the first profile and the second profile using the ontology information from the ontology information base; and
a competitiveness metric calculator for calculating, based on the normalized first and second profiles, a competitiveness metric between the first and second objects.

23. The system according to claim 22, wherein the ontology information is a common attribute name vocabulary, which includes the names of object's attributes selected by importance for the competitiveness of the attributes, and
wherein the normalizing means further comprises:
a determining unit for determining profile types of the first and second profiles;
a unified profile structure generation unit for generating, according to the determined profile types, a unified profile structure by referring to the common attribute name vocabulary; and
an alignment unit for aligning the respective attributes in the first and second profiles with the corresponding attributes in the unified profile,
wherein the competitiveness metric calculator further comprises:
a competitiveness sub-metric calculating unit for calculating a competitiveness sub-metric for each pair of corresponding attributes in the aligned first and second profiles; and
a competitiveness metric calculating unit for obtaining the competitiveness metric between the first and second objects by calculating the weighted sum of the competitiveness sub-metrics of all attributes in the first and second profiles,
wherein the system further comprises a competitiveness weighting policies base for storing weight coefficients required for the weighting.

24. The system according to claim 22, wherein the ontology information is an object category tree, of which each node represents an object category and includes one or more representative profiles, and
wherein the normalizing means further comprises:
a mapping unit for mapping each of the first and second profiles to one or more nodes of the object category tree, and
wherein the competitiveness metric calculator comprises:
a semantic distance obtaining unit for obtaining a semantic distance between each pair of nodes of the object category tree; and
a competitiveness metric calculating unit for calculating the competitiveness metric between the first and second objects based on the obtained semantic distances.

25. The system according to claim 24, wherein the competitiveness metric calculator further comprises:
a mapping probability calculating unit for calculating, for each of the first and second profiles, a probability of mapping it to each of corresponding nodes of the object category tree, and
wherein the competitiveness metric calculating unit is configured for calculating the competitiveness metric between the first and second objects based on the calculated mapping probabilities of the first and second profiles and the obtained semantic distances between the nodes to which the first and second profiles are mapped.

26. The system according to claim 23, wherein the competitiveness sub-metric calculating unit further comprises:
a attribute type determining unit for determining the type of a first and a second attributes with reference to the common attribute name vocabulary, the first and a second attributes being a pair of corresponding attributes in the first and second profiles and from the first and second profiles respectively;
a sub-metric measure selector for selecting a competitiveness sub-metric measure according to the determined attribute type; and
a sub-metric calculator for calculating the competitiveness sub-metric between the first and second attribute with the selected competitiveness sub-metric measure.

27. The system according to claim 26, wherein the sub-metric calculator uses a Vector Space Model (VSM)-based measure or an attribute-based measure to calculate the competitiveness sub-metric.

28. The system according to claim 27, wherein when the VSM-based measure is used to calculate the competitiveness sub-metric, the sub-metric calculator further comprises:
a vectoring unit for generating a first vector and a second vector, which are both based on words, representative of the first and second attributes respectively; and
a VSM-based sub-metric calculator for using the VSM-based measure to calculate a competitiveness metric between the first and second vectors as the competitiveness sub-metric between the first and second attributes.

29. The system according to claim 28, wherein the sub-metric calculator further comprises:
a preprocessing unit coupled to the vectoring unit for preprocessing the first and second attributes to delete named entities from text of each attribute's value before generating the first and second vectors.

30. The system according to claim 29, wherein the named entities include proper none, company name and product name.

31. The system according to claim 28, wherein the sub-metric calculator further comprises:
a domain and POS analysis module for performing a domain and POS analysis on the words in the first and second attributes, and
wherein the vectoring unit is configured for before generating the first and second vectors, according to the result of the domain and POS analysis, weighting the words in the first and second attributes with reference to a previously stored competitiveness weight coefficients rules table related to the competitiveness.

32. The system according to claim 31, wherein the competitiveness weight coefficients rules table is stored in the competitiveness weighting policies base.

33. The system according to claim 31, wherein the competitiveness weight coefficients rules table is built manually by user.

34. The system according to claim 31, wherein the competitiveness weight coefficients rules table is built through an automatic way by performing keywords extraction based on the ontological object information from third party websites.

35. The system according to claim 31, wherein the competitiveness weight coefficients rules table is configured for storing a competitiveness weight coefficient associated with each word, which represents the importance of the word in calculating the competitiveness metric.

36. The method according to claim 35, wherein in the competitiveness weight coefficients rules table, a word un-related to the domain to which the compared first and second objects belong is provided a lower competitiveness weight coefficient than a word related to the domain, and for the words which each has a POS making no contribution to the calculation of the competitiveness metric, their competitiveness weight coefficients are set to zero.

37. The system according to claim 24, wherein the one or more representative profiles at each node correspond to different languages.

38. The system according to claim 24, wherein the mapping unit is configured for using the one or more representative profiles at each node of the object category tree as a medium to perform the mapping of the first and second profiles to the nodes of the object category tree by using a VSM-based measure.

39. The system according to claim 24, wherein when each of the first and second profiles is mapped to a single node, the competitiveness metric calculating unit is configured for using the semantic distance between the mapped nodes directly as the competitiveness metric between the first and second objects.

40. The system according to claim 25, wherein when each of the first and second profiles is mapped to a plurality of nodes, the competitiveness metric calculating unit is configured for generating a first category vector and a second category vector based on the probabilities of mapping the first and second profiles to the respective nodes of the object category tree, and calculating the competitiveness metric between the first and second objects by utilizing a cosine measure of the first and second category vectors.

41. The system according to claim 40, wherein the semantic distances between the nodes that the first and second profiles are mapped to are integrated into the cosine measure to calculate the competitiveness metric between the first and second objects.

42. The system according to claim 24, wherein the semantic distances between respective nodes of the object category tree are computed in advance and stored with the object category tree in the ontology information base.

43. The system according to claim 24, wherein on the object category tree, a semantic distance between nodes in a higher level is bigger than that between nodes in a lower level, and a semantic distance between “sibling” nodes is bigger than that between a “parent” node and a “child” node.
